(19) United States
(12) Patent Application Publication
(10) Pub. No.: US 2023/0071253 A1
(43) Pub. Date: Mar. 9, 2023

(54) EVOLVING MULTI-OBJECTIVE RANKING MODELS FOR GROSS MERCHANDISE VALUE OPTIMIZATION IN E-COMMERCE

(71) Applicant: ETSY, Inc., Brooklyn, NY (US)

(72) Inventors: Andrew Stanton, Brooklyn, NY (US); Akhila Ananthram, Brooklyn, NY (US)

(73) Assignee: ETSY, Inc., Brooklyn, NY (US)

(21) Appl. No.: 17/790,544

(22) PCT Filed: Feb. 5, 2021
(86) PCT No.: PCT/US2021/070130

§ 371 Date: Jul. 1, 2022

Related U.S. Application Data
(60) Provisional application No. 62/971,004, filed on Feb. 6, 2020.

(51) Int. Cl. G06Q 30/02; G06N 3/12

(52) U.S. Cl. CPC G06Q 30/0271; G06Q 30/0201; G06N 3/126

(57) ABSTRACT

An enhanced ranking approach is used to evaluate selected metrics for various services, including search and recommendations for online marketplaces and other search engine-related applications. This includes a ranking system capable of learning neural networks which efficiently tradeoff between different business objectives. For instance, a hybridized ranking system combines the strength of relevancy focused models with the flexibility of ES via ensembling to solve multi-objective ranking problems.

### CROSS-REFERENCE TO RELATED APPLICATIONS

This application claims the benefit of the filing date of U.S. Provisional Application No. 62/971,004, filed Feb. 6, 2020, the entire disclosure of which is incorporated by reference herein.

### BACKGROUND

Modern day e-commerce companies learn and deploy complex search ranking systems, attempting to blend product relevancy with business constraints, usually in the form of rules. For instance, these types of companies may learn and deploy complex search ranking models which, given a query, attempt to order products on page with the end goal of maximizing the likelihood a buyer finds and purchases a product. However, there are often competing objectives beyond relevancy that drive growth or deliver stronger bottom-line performance which are often enforced sub-optimally as hard rules and heuristics. As an additional complication, the objectives of interest are often discontinuous, challenging standard optimization approaches.

### BRIEF SUMMARY

Aspects of the technology provide an enhanced ranking approach, including a production grade ranking system capable of learning neural networks which efficiently tradeoff between different business objectives. Real world experiments validate the approach in a large-scale production search engine.

According to one aspect, a computer-implemented ensembling method comprises selecting a set of features in a document associated with a product offered in an online marketplace; applying, by one or more processors of a computing system, at least a first subset of the selected set of features and information about the product from the document to a first relevancy model to generate a first product-based prediction; applying, by the one or more processors of the computing system, at least a second subset of the selected set of features and the first product-based prediction to a second relevancy model different from the first relevancy model to generate a second product-based prediction; applying, by the one or more processors of the computing system, at least a third subset of the selected set of features and the second product-based prediction to an Evolutionary Strategies model to generate an ensemble output optimizing a selected metric associated with the product; and modifying an ordering of product documents based on the ensemble output from the Evolutionary Strategies model.

In one example, the first relevancy model is a linear model. In another example, the second relevancy model is a Gradient Boosted Decision Tree model. In a further example, the Evolutionary Strategies model employs a fully connected two-layer neural network. Here, the fully connected two-layer neural network may be optimized using a multi-objective optimizer. In yet another example, the first relevancy model is a linear model, the second relevancy model is a Gradient Boosted Decision Tree model, and the Evolutionary Strategies model employs a fully connected two-layer neural network.

In another example, the first relevancy model is trained over a first time window and the second relevancy model is trained over a second time window. In this case, the second time window may have a different scale than the first time window. In a further example, the selected metric associated with the product is Gross Merchandise Value (GMV).

In a further example, the method also includes optimizing the Evolutionary Strategies model according to a maximized fitness function. Here, the maximized fitness function may be composed of a linear combination a set of metrics including an average purchase normalized discounted cumulative gain (NDGC) and a median price. And in another example, the first, second and third subsets of the selected set of features are identical.

The selected set of features may include an ensemble relevancy score, a listing price, a query, a product title, and one or more similarity scores. The query may be a textual query associated with the product offered in the online marketplace.

Modifying the ordering of product documents based on the ensemble output from the Evolutionary Strategies model may include modifying a first set of product documents of a first side of the online marketplace and modifying a second set of product documents of a second side of the online marketplace. The first side of the online marketplace may be associated with a set of shops or listings, and the second side of the online marketplace may be associated with customers. The method may further comprise evaluating a sales promotion based on results from modifying the ordering of product documents based on the ensemble output from the Evolutionary Strategies model.

The method may further include dynamically allocating between multiple types of content in a fixed layout space based on the ensemble output. Dynamically allocating may include distributing, by the one or more processors of the computing system, the product documents that represent items or shops to allocate one or more promotional resources in a campaign to promote selected products. At least one of a layout and an allocation may be varied by the one or more processors of the computing system according to a set of factors. The set of factors may include at least one of a customer device size, a layout size for the customer device, bandwidth, subject matter, or a user preference.

The method may further comprise optimizing the method according to one or more secondary considerations associated with either a search situation or a recommendation situation. The one or more secondary considerations may be selected from the group consisting of topical diversity, seller diversity, and temporal diversity.

According to another aspect, a non-transitory computer-readable recording medium having instructions stored thereon is provided. The instructions, when executed by one or more processors, cause the one or more processors to perform the ensembling method according to any of the above-recited examples, alternatives or variations.

And according to a further aspect, a marketplace server system of an online marketplace is provided. The marketplace server system comprises at least one database and one or more processors. The at least one database is configured to store information including one or more of merchant data, documents associated with products offered in the online marketplace, promotional content, user preferences, textual queries, relevancy models and an Evolutionary Strategies model. The one or more processors are operatively coupled to the at least one database. The one or more processors are configured to: select a set of features in a document associated with a product offered in the online marketplace; apply at least a first subset of the selected set of features and information about the product from the document to a first relevancy model to generate a first product-based prediction; apply at least a second subset of the selected set of features and the first product-based prediction to a second relevancy model different from the first relevancy model to generate a second product-based prediction; apply at least a third subset of the selected set of features and the second product-based prediction to an Evolutionary Strategies model to generate an ensemble output that optimizes a selected metric associated with the product; and modify an ordering of product documents based on the ensemble output from the Evolutionary Strategies model.

### BRIEF DESCRIPTION OF DRAWINGS

FIG. 1 illustrates an example ensemble logic in accordance with aspects of the disclosure.

FIG. 2 illustrates a chart of Pareto frontier metrics in accordance with aspects of the disclosure.

FIG. 3 illustrates a table on online experimental results in accordance with aspects of the disclosure.

FIG. 4 illustrates a plot of treatment and control distributions in accordance with aspects of the disclosure.

FIG. 5 illustrates a conditional average treatment effect plot in accordance with aspects of the disclosure.

FIGS. 6A-B illustrate an example system in accordance with aspects of the disclosure.

FIG. 7 illustrates a processing system in accordance with aspects of the disclosure.

FIG. 8 illustrates a flowchart in accordance with aspects of the disclosure.

FIG. 9 illustrates a method in accordance with aspects of the disclosure.

### DETAILED DESCRIPTION

### Introduction

Online shopping is rapidly becoming the dominant avenue for consumers to find and purchase goods. Fueled by an ever-increasing set of inventory, reliance on search technologies continues to grow. While metrics such as buyer Conversion Rate (CVR) are still considered the top metric for driving Gross Merchandise Value (GMV), e-commerce websites such as Ebay, Etsy, Amazon, and Taobao have started investigating additional metrics thought important to marketplace growth such as price, topical diversity, recency, and more.

While learning to rank has been tackled within the evolutionary algorithm space before, approaches have primarily focused on optimizing a single relevancy metric rather than address the multi-objective space. Another approach uses Evolutionary Strategies (ES) to balance between multiple objectives in the e-commerce space but only explores offline analysis. Categorically, however, the above methods substantially under-perform non-EA approaches in relevancy, discouraging production usage.

The present technology provides a hybridized ranking system which combines the strength of relevancy focused models with the flexibility of ES via ensembling to solve multi-objective ranking problems. This avoids tradeoffs that could otherwise affect different discrete approaches. Real-world experimental results validate the efficacy of the approach in a large-scale production e-commerce search engine.

### Approach

In some instances, models have been trained to optimize for purchase using a normalized discounted cumulative gain (NDGC) based on the ranking of an item list of search results, such as NDCG, due to user behavior and the strong correlation to CVR in the e-commerce space. This may be achieved via an ensemble of sparse logistic regression models and Gradient Boosted Decision Trees (GBDT), using a weighted combination of user clicks, cart adds, and purchases (and/or other features associated with a product) to model relevancy. These models may be trained using a processing system over various time windows (e.g., days, weeks, months, quarters, etc.) to capture seasonality and are arrayed in a sequential manner, with linear models feeding into the GBDTs. The system is able to handle a wide variety of different features in order to maximize or otherwise optimize a particular element or other criteria. This can include, for instance, optimization of non-differentiable metrics such as percentiles.

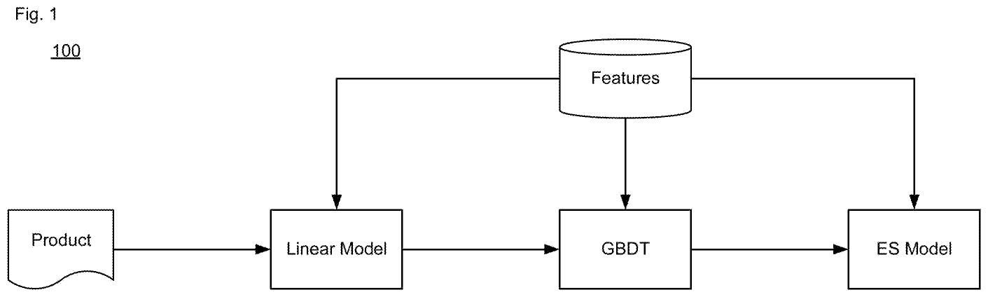

FIG. 1 illustrates an example ensemble logic 100 in which relevancy models feed their predictions into the ES model along with the original feature set. For instance, the relevancy models can include one or both of a linear model and a GBDT model. As shown, product information and selected features are applied to a linear model. The predictions from the linear model are fed into the GBDTs along with the feature information. And the predictions output by the GBDTs are fed into the ES model along with the feature information. The results from the ES model may be used in various applications, such as marketplace optimization, dynamic resource allocation and direct diversity optimization, which are discussed below. In alternatives, the ensemble logic need not employ all of the stages illustrated in FIG. 1. In one example, the ES model could be used without input from the linear model and/or GBDTs.

In one example, when optimizing GMV, there are two main factors to be considered: Conversion Rate and the Average Order Value (AOV). In particular, they may be evaluated according to the following equation:

GMV=CVR×AOV (1)

To approximate AOV, a proxy metric may be used, such as the median price of the first item in a ranked list, for instance, of search results. This approximation may be suitable for several reasons. First, due to the cascading click model, prices higher in the ranked lists may be more likely to be purchased. Secondly, higher prices may earlier or higher in the list will have an anchoring effect on all subsequent observations. Furthermore, rather than model relevancy with an evolutionary solution, which has shown to under-perform in certain use cases, aspects of the technology may add a third pass model, adding the output scores of the relevancy models. The third model, a two-layer neural network implemented by the processing system, can be optimized using the multi-objective optimizer outlined in “Revenue, Relevance, Arbitrage and More: Joint Optimization Framework for Search Experiences in Two-Sided Marketplaces” (which was included as Appendix I in the provisional application, and which is incorporated by reference in its entirety), which is summarized below.

Metrics, such as NDCG, may rely on sorting to evaluate a ranked list and are subsequently non-differentiable. NDCG is an ordered relevance metric measuring the agreement between a goldset list of documents and the permutation return by the ranking policy. To account for this non-differentiable challenge, one aspect of the technology may utilize a Canonical Evolutionary Strategies optimizer, maximizing a fitness function composed of a linear combination of these different metrics: average Purchase NDCG and median Price. The fitness function can be expressed as:

F=C₁·NDCG+C₂·Price (2)

where C₁ and C₂ are constants used to weight the importance of the different metrics, NDCG is the average Purchase NDCG, and Price is the median Price.

A two-layer neural network, such as a fully connected two-layer neural network, may be trained using the rectified linear unit (ReLU) activation as a pointwise policy, exploring a variety of different weights toward each of the metrics. In one example, over 200 different features may be included, composed of query and product attributes and relevancy model scores. In other examples, more or fewer features maybe included. Example features may include, for example, the ensemble relevancy score, listing price, query, product title, similarity scores, etc. For consistency, the relevance models (both linear and GBDT) and the learned neural net may utilize the same feature set.

### Experimental Results

In one example, a system may be trained on purchase requests from the previous X days, evaluating the model on the following day of data. To determine the weight coefficients in the fitness function, the Pareto frontier of the two metrics was explored. The approach was able to trade-off between the two metrics smoothly, ultimately selecting C₁=0.88 and C₂=0.12 in 2, allowing the system to keep conversion rate stable while improving on our price metric.

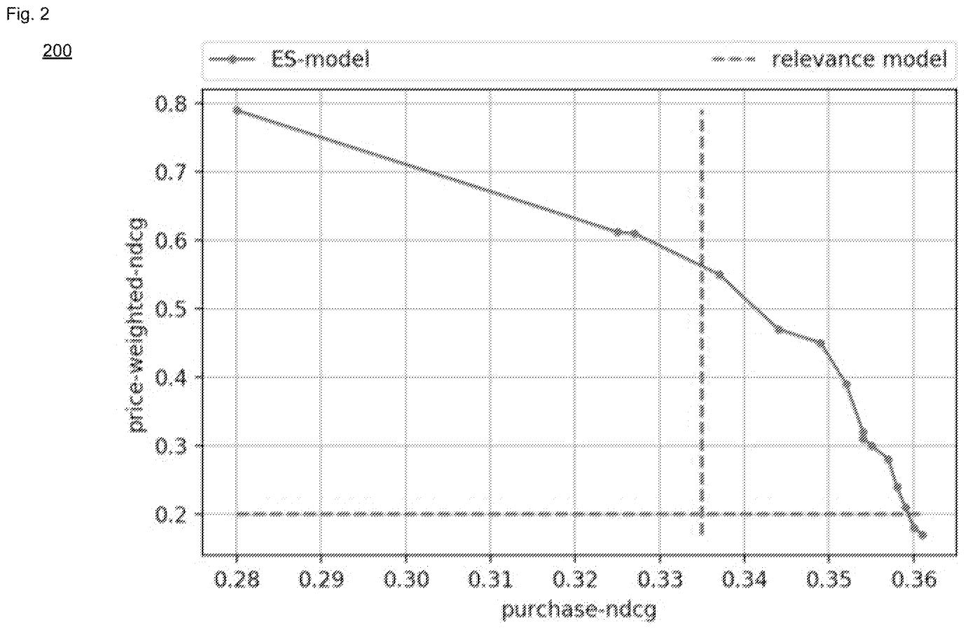

FIG. 2 illustrates a chart 200 of Pareto frontier metrics, plotting the ES-model (solid line with circular data points) versus the relevance model (dashed lines) with respect to “purchase-ndcg” (x-axis) and “price-weighted-ndcg” (y-axis).

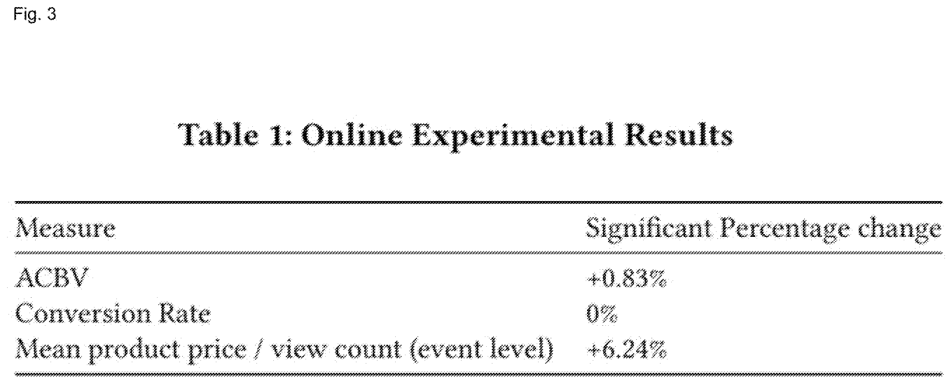

One scenario implemented an online AB experiment to compare the learned model to a current model. FIG. 3 presents a table (Table 1) of the online experimental results including average converting browser value (ACBV) and conversion rate, showing the significant percentage change for different metrics (e.g., for mean product price/view count (event level)).

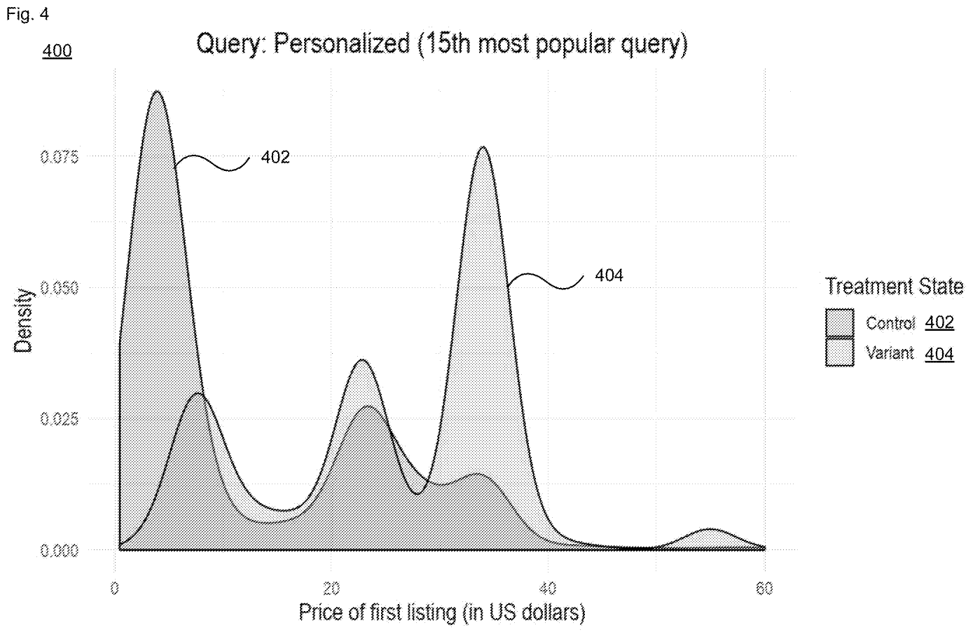

The results suggested significant positive differences (at α=0.05) among treated and control units in terms of average converting browser value and the mean product price viewed, indicating buyers indeed viewed and ordered more expensive products (see FIG. 4). Conversion rate was not impacted, providing evidence demand remained stable throughout the experiment.

To better understand the impact of the new model, the distributions of treatment and control in terms of Price@1 (the price of the first listing in a set of listings) were compared, as shown in plot 400 of FIG. 4. For the given query (e.g., the term “personalized”), the plot shows a rightwise shift of the treated units density (404) away from the control units density (402). Similar behavior has been observed from other top queries, suggesting that Price@1 is consistent with the behavior expected from Table 1.

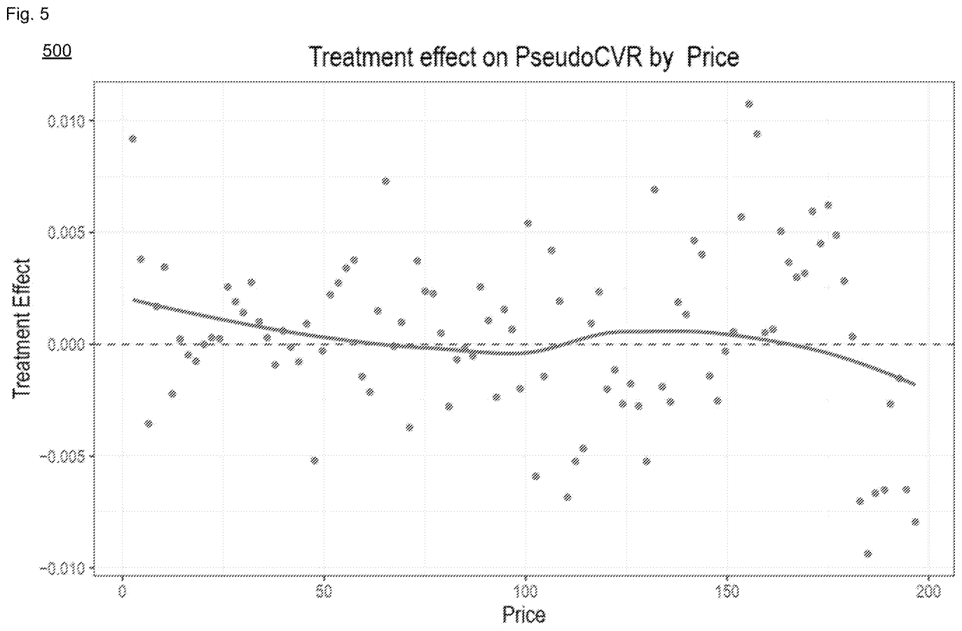

To complement the results on demand metrics from the overall experiment, a metric that is called “PseudoCVR” is evaluated. This metric is the number of purchases by requests divided by the number of interactions within a request. It may be beneficial to see the changes of this demand function accounting for heterogeneity across prices. To do so, the conditional average treatment effect (CATE) is evaluated by utilizing causal forests to generate plot 500 in FIG. 5. The plot 500 shows that while CATE stays close to zero, the trend (as shown by the solid line) is that demand shows that the algorithm has positive effects over the control on the cheapest items (e.g., items with a price between 0 and 50, where the solid line is in the positive range between 0.005 and 0.000 for the treatment effect). Moreover, there is a negative effect at the highest price levels (e.g., items with a price between 175 and 200, where the solid line dips below 0.000 for the treatment effect). Note, however, that all these treatment effects stay close to zero, confirming the claim of demand stability in accordance with aspects of the technology.

### Example Implementations

There are various scenarios and environments in which the technology described herein may be applied. Several example applications are discussed below.

### Application 1—Marketplace Optimization

Machine learning models may learn to tradeoff between market level metrics and economic indicators for searches in a two-sided marketplace, such as between a group of merchants and potential customers. The above-identified ensemble approach provides a new methodology and metrics that can be used to balance between multiple different needs, allowing a system to optimize specifically for the economy. For instance, the ensemble approach can be used to evaluate metrics that are of particular relevance to each side of the marketplace. As seen in above regarding the plot in FIG. 5, this approach may help explain different behaviors on each side of the marketplace, and to account for them in a mutually beneficial manner. This can be applied to modify the search rank of documents representing users on both sides of the two sided marketplace, such as shops (e.g., retailers, wholesalers or other vendors), listings, or users (e.g., purchasers or other customers), either in general or in a personalized manner (with privacy controls). Also, in a two-sided marketplace, the system could be used to evaluate sales promotions. Outside of a two-sided marketplace, the system could be used for hyperparameter tuning.

### Application 2—Dynamic Resource Allocation

Models may be evolved to dynamically allocate between multiple types of content in a fixed layout space. One example would be balancing ad buckets with organic search results, optimizing for some balance of GMV and revenue. This could enable merchants and/or the marketplace itself to distribute documents representing items or shops in order to effectively allocate advertising or other promotional resources in a campaign to promote selected products, either in general or on a personalized basis (with privacy controls). The layout and allocation may vary based on such factors as device and layout size, bandwidth, subject matter and user preferences.

### Application 3—Direct Diversity Optimization

Models can also be evolved that directly optimize for secondary considerations within search and recommendations situations, such as topical, seller, and temporal diversity. This improvement provides more efficient models and greater impact on result sets. Optimizing for secondary considerations can provide enhanced flexibility to the user (e.g., a merchant or the marketplace).

### Example System

The ranking system technology may be implemented using one or more algorithms (such as the code examples of Appendix II) executed by a processing system.

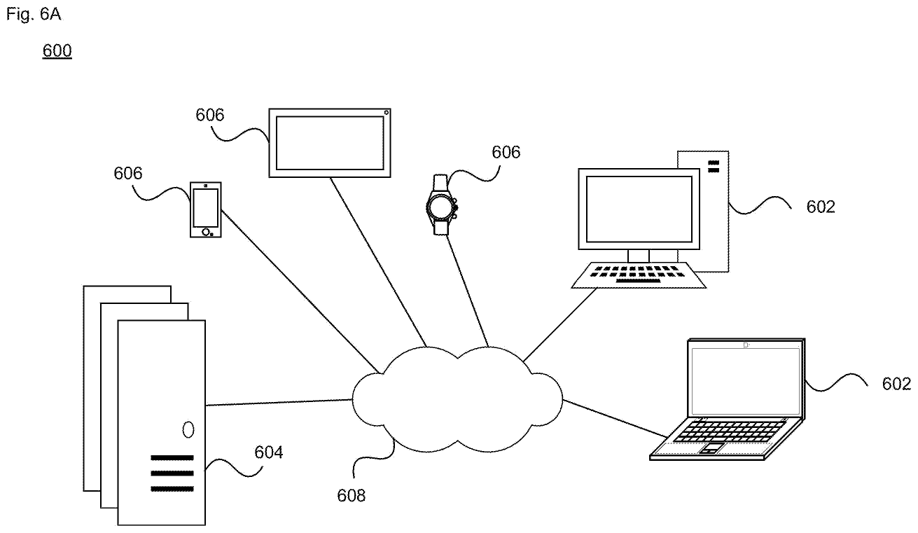

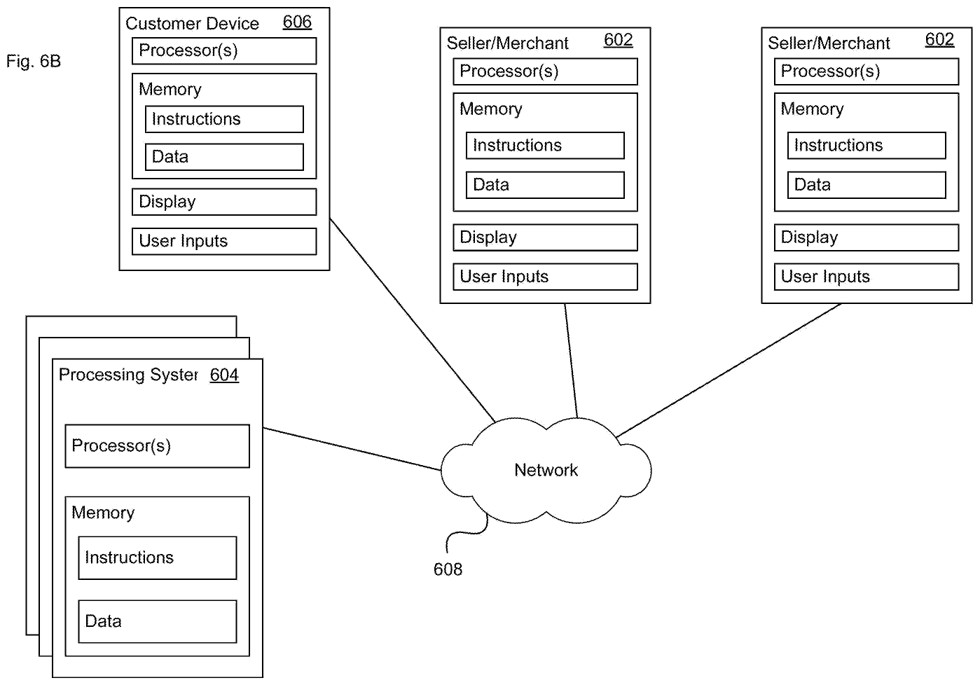

FIGS. 6A-B illustrate an example system that includes merchant devices 602, a processing system 604, and customer devices 606, which may be connected directly or indirectly via network 608. While only a few devices are shown, there may be many (e.g., hundreds or thousands) merchant devices and customer devices. As illustrated in FIG. 6A, the merchant devices 602 may be desktop or laptop client computer devices, although other types of computers may be employed. The processing system 604 may be a server system of one or more computing devices, as discussed below. Customer devices 606 may include, by way of example, mobile phones, tablet PCs, smartwatches or other wearables, laptops, netbooks, desktops, etc. As shown in FIG. 6B, each of these devices may include processors and memory for storing instructions and data. The merchant and customer devices may also include UI components to receive user inputs and present information to a person, for instance via one or more display devices.

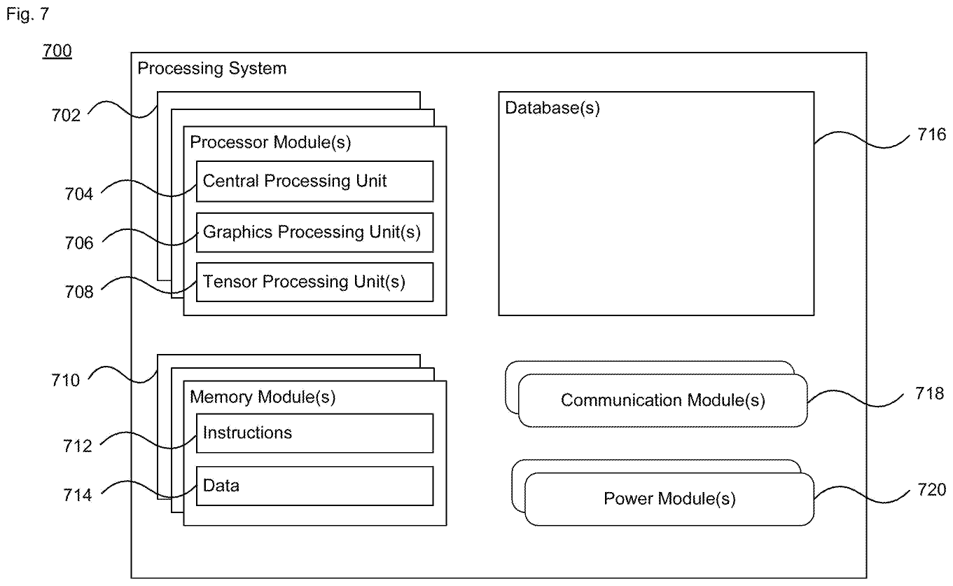

FIG. 7 illustrates an example arrangement 700 of the processing system 604. As shown, the processing system 700 may be a server-type system that may be employed with the techniques disclosed herein, either locally, in a dedicated facility, or via a cloud based server system. Here, the server system includes at least one processing module 702 that has a set of computer processors. The set of processors may comprise, e.g., a central processing unit (CPU) 704, graphics processing units (GPUs) 706, and/or tensor processing units (TPUs) 708. One or more memory modules 710 are configured to store instructions 712 and data 714, including algorithms and/or software modules such as those of Appendix II.

The processors may be configured to operate in parallel. Such processors may include ASICs, controllers and other types of hardware circuitry. The memory module(s) 710 can be implemented as one or more of a computer-readable medium, a volatile memory unit, or a non-volatile memory unit. The memory module(s) 710 may include, for example, flash memory or NVRAM. These module(s) may be embodied as one or more hard-drives or memory cards. Alternatively, the memory module(s) 710 may also include optical discs, high-density tape drives, and other types non-transitory memories. The instructions 712, when executed by one or more processors of the marketplace computing system, perform operations such as those described herein. Although FIG. 7 functionally illustrates the processor(s), memory module, and other elements of the processing system 700 as being within the same overall block, such components may or may not be stored within the same physical housing. For example, some or all of the instructions and data may be stored on an information carrier that is a removable storage medium (e.g., optical drive, high-density tape drive or USB drive) and others stored within a read-only computer chip. The system may be implemented in a cloud-based shared infrastructure, with specialized server and processor types such as one or more processor clusters reserved to expedite certain key tasks such as machine learning, data optimization, or content distribution with functions accessible, for example, directly or via an API.

The data 714 may be retrieved, stored and/or modified by the processors in accordance with the instructions 712. Although the subject matter is not limited by any particular data structure, the data may be stored in computer registers, in a relational database as a table having a plurality of different fields and records, a data stream processed in real time, XML documents, etc. The instructions 712 may be any set of instructions to be executed directly, such as machine code, or indirectly, such as scripts, by one or more processors.

One or more databases 716 may be stored in the memory module(s) 710 or stored in separate non-transitory memory. In one example, the databases 716 may include a merchant database, a listings database, an analytics database, an advertising database, a query database and/or a pricing database. While the databases are shown as being part of a single block, the information for each database may be stored in discrete databases. The databases may be distributed, for instance across multiple memory modules or other storage devices of a cloud computing architecture. The databases may be run, depending on scale, via a number of different frameworks, including, for example, traditional query languages such as MySQL, bigdata Hadoop clusters, or stream processing.

As also shown in FIG. 7, the processing system 300 includes one or more communication modules 718 for communicating with other devices and systems, including merchant devices, customer devices and other devices in the network. The communication module(s) 718 may include one or more wireless transceivers, and/or one or more wired transceivers. The processing system 700 may communicate with remote devices via the communication module 718 using various configurations and protocols, including but not limited to local area network (LAN) and/or wide area network (WAN) configurations. Various standard protocols, such as 802.3 (Ethernet) and 802.11 (wireless LANs) may be employed, although these are nonlimiting examples. In addition, the processing system 700 as shown also includes one or more power module 720. The power module(s) 720 are configured to supply power to the other modules of the processing system 700.

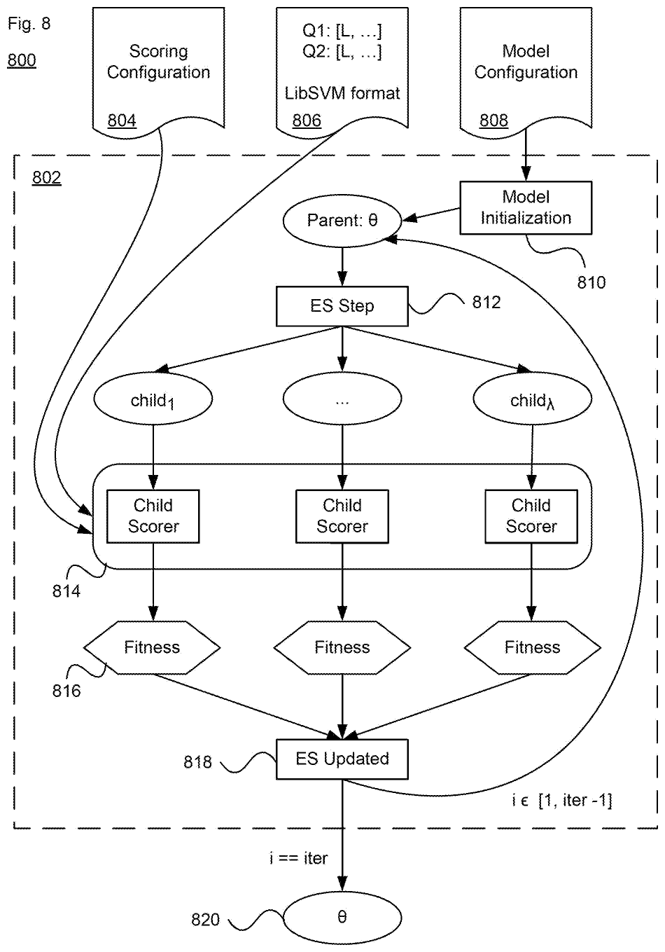

FIG. 8 illustrates an example flowchart 800 of how a framework 802 in accordance with the foregoing learns a new model. For instance, the framework 802 may support custom optimization goals, including market level metrics. In this example, scoring configurations and policy configurations 804 are inputs to the framework 802. These configurations specify what metrics to optimize for, and how to weight each metric in the final fitness function computation. By way of example, the weights are hyperparameters that are supplied as inputs, not learned by the model's framework. Training/validation data 806 may be provided separately (e.g., in LibSVM format). Model and optimizer configurations 808 are passed as separate arguments at training time to the model initialization block 810.

As shown in FIG. 8, upon model initialization 810 based on the model configuration 808, the framework 802 includes instantiating a set of child objects (1, . . . , λ) from a parent (θ) via an evolutionary strategies operation (ES Step) at block 812. Block 814 includes a set of child scorer modules corresponding to each child object. Corresponding fitness functions 816 are applied to the output of the child scorer modules, and those results are input to another evolutionary strategies operation (ES Updated) at block 818. The information from this ES operation is the output of the framework as shown at block 820, and this information may also be fed back to the parent as indicated.

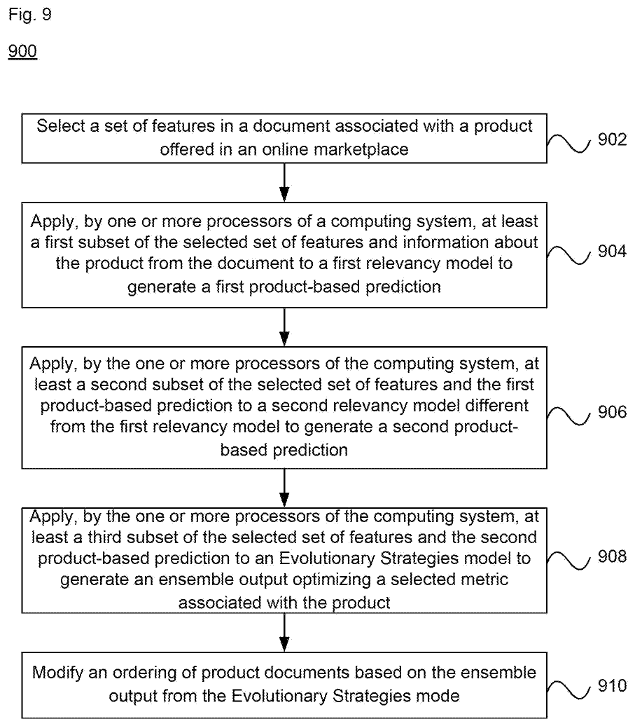

FIG. 9 illustrates a computer-implemented ensembling method 900 in accordance with aspects of the technology. At shown at block 902, the method includes selecting a set of features in a document associated with a product offered in an online marketplace. At block 904, the method includes applying, by one or more processors of a computing system, at least a first subset of the selected set of features and information about the product from the document to a first relevancy model to generate a first product-based prediction. At block 906, the method includes applying, by the one or more processors of the computing system, at least a second subset of the selected set of features and the first product-based prediction to a second relevancy model different from the first relevancy model to generate a second product-based prediction. At block 908, the method includes applying, by the one or more processors of the computing system, at least a third subset of the selected set of features and the second product-based prediction to an Evolutionary Strategies model to generate an ensemble output optimizing a selected metric associated with the product. And at block 910, the method includes modifying an ordering of product documents based on the ensemble output from the Evolutionary Strategies model.

The following are code examples that relate to aspects of the technology discussed herein.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. As used in this document, “each” refers to each member of a set or each member of a subset of a set.

To aid the Patent Office and any readers of any patent issued on this application in interpreting the claims appended hereto, Applicant notes that it does not intend any of the appended claims or claim elements to invoke 35 U.S.C. 112(f) unless the words “means for” or “step for” are explicitly used in the particular claim.

1. A computer-implemented ensembling method, comprising:
selecting a set of features in a document associated with a product offered in an online marketplace;
applying, by one or more processors of a computing system, at least a first subset of the selected set of features and information about the product from the document to a first relevancy model to generate a first product-based prediction;
applying, by the one or more processors of the computing system, at least a second subset of the selected set of features and the first product-based prediction to a second relevancy model different from the first relevancy model to generate a second product-based prediction;
applying, by the one or more processors of the computing system, at least a third subset of the selected set of features and the second product-based prediction to an Evolutionary Strategies model to generate an ensemble output optimizing a selected metric associated with the product; and
modifying an ordering of product documents based on the ensemble output from the Evolutionary Strategies model.

2. The computer-implemented ensembling method of claim 1, wherein the first relevancy model is a linear model.

3. The computer-implemented ensembling method of claim 1, wherein the second relevancy model is a Gradient Boosted Decision Tree model.

4. The computer-implemented ensembling method of claim 1, wherein the Evolutionary Strategies model employs a fully connected two-layer neural network.

5. The computer-implemented ensembling method of claim 4, wherein the fully connected two-layer neural network is optimized using a multi-objective optimizer.

6. The computer-implemented ensembling method of claim 1, wherein the first relevancy model is a linear model, the second relevancy model is a Gradient Boosted Decision Tree model, and the Evolutionary Strategies model employs a fully connected two-layer neural network.

7. The computer-implemented ensembling method of claim 1, wherein the first relevancy model is trained over a first time window and the second relevancy model is trained over a second time window.

8. The computer-implemented ensembling method of claim 7, wherein the second time window has a different scale than the first time window.

9. The computer-implemented ensembling method of claim 1, wherein the selected metric associated with the product is Gross Merchandise Value (GMV).

10. The computer-implemented ensembling method of claim 1, further comprising optimizing the Evolutionary Strategies model according to a maximized fitness function.

11. The computer-implemented ensembling method of claim 10, wherein the maximized fitness function is composed of a linear combination a set of metrics including an average purchase normalized discounted cumulative gain (NDGC) and a median price.

12. The computer-implemented ensembling method of claim 1, wherein the first, second and third subsets of the selected set of features are identical.

13. The computer-implemented ensembling method of claim 1, wherein the selected set of features includes an ensemble relevancy score, a listing price, a query, a product title, and one or more similarity scores.

14. The computer-implemented ensembling method of claim 13, wherein the query is a textual query associated with the product offered in the online marketplace.

15. The computer-implemented ensembling method of claim 1, wherein modifying the ordering of product documents based on the ensemble output from the Evolutionary Strategies model includes modifying a first set of product documents of a first side of the online marketplace and modifying a second set of product documents of a second side of the online marketplace.

16. The computer-implemented ensembling method of claim 15, wherein the first side of the online marketplace is associated with a set of shops or listings, and the second side of the online marketplace is associated with customers.

17. The computer-implemented ensembling method of claim 15, further comprising evaluating a sales promotion based on results from modifying the ordering of product documents based on the ensemble output from the Evolutionary Strategies model.

18. The computer-implemented ensembling method of claim 1, further comprising dynamically allocating between multiple types of content in a fixed layout space based on the ensemble output.

19. The computer-implemented ensembling method of claim 18, wherein dynamically allocating includes distributing, by the one or more processors of the computing system, the product documents that represent items or shops to allocate one or more promotional resources in a campaign to promote selected products.

20. The computer-implemented ensembling method of claim 19, wherein at least one of a layout and an allocation are varied by the one or more processors of the computing system according to a set of factors.

21. The computer-implemented ensembling method of claim 20, wherein the set of factors includes at least one of a customer device size, a layout size for the customer device, bandwidth, subject matter, or a user preference.

22. The computer-implemented ensembling method of claim 1, further comprising optimizing the method according to one or more secondary considerations associated with either a search situation or a recommendation situation.

23. The computer-implemented ensembling method of claim 22, wherein the one or more secondary considerations are selected from the group consisting of topical diversity, seller diversity, and temporal diversity.

24. A marketplace server system of an online marketplace, the marketplace server system comprising:
at least one database configured to store information including one or more of merchant data, documents associated with products offered in the online marketplace, promotional content, user preferences, textual queries, relevancy models and an Evolutionary Strategies model; and
one or more processors operatively coupled to the at least one database, the one or more processors being configured to:
select a set of features in a document associated with a product offered in the online marketplace;
apply at least a first subset of the selected set of features and information about the product from the document to a first relevancy model to generate a first product-based prediction;
apply at least a second subset of the selected set of features and the first product-based prediction to a second relevancy model different from the first relevancy model to generate a second product-based prediction;
apply at least a third subset of the selected set of features and the second product-based prediction to an Evolutionary Strategies model to generate an ensemble output that optimizes a selected metric associated with the product; and
modify an ordering of product documents based on the ensemble output from the Evolutionary Strategies model.

25. A non-transitory computer-readable recording medium having instructions stored thereon, the instructions, when executed by one or more processors, cause the one or more processors to perform the ensembling method according to claim 1.
